(19) United States
(12) Patent Application Publication
(10) Pub. No.: US 2007/0229234 A1
(43) Pub. Date: Oct. 4, 2007

(54) B Alert

(76) Inventor: James C. Smith, Fort Wayne, IN (US)

Correspondence Address: JAMES C SMITH, 1305 THREE RIVERS EAST, FORT WAYNE, IN, 46802, US

(21) Appl. No.: 11/396,320

(22) Filed: Apr. 3, 2006

(51) Int. Cl. B60Q 1/00; H04B 1/38

(52) U.S. Cl. 340/425.5; 455/565; 455/567

(57) ABSTRACT

Protection against the distractions of cell phone use while operating a motor vehicle. In addition, protection against falling asleep while operating a motor vehicle whether or not using a cell phone. An alarm is activated when cell phone use is detected and in the “Sleep” mode an alarm can be manually or automatically activated to keep a sleepy driver alert.

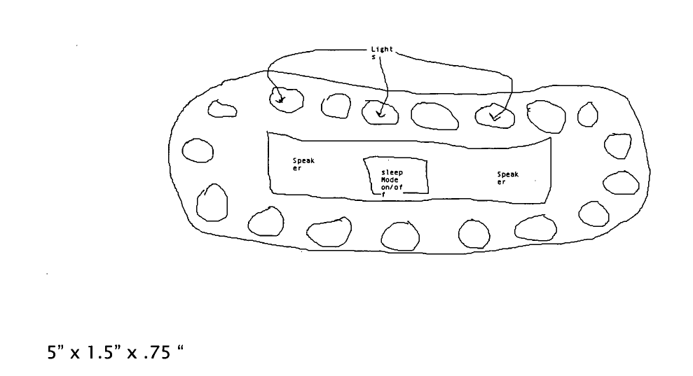

The “B Alert” is a wireless device that is designed to recognize when a cell phone is in use. The device will then at random moments activate an alarm: a random series of sounds for a random set of seconds and the random sequential flashing of different colored warning lights for a random set of seconds. This will continue for as long as the device recognizes a cell phone in use signal. In addition, the device has a “Sleep Alert” function that can be manually or automatically activated to trigger the light/sound random feature even when a cell phone is not in use.

By sounding the alarm the Cell Phone user/Driver's attention is directed to the device which is displayed in or around the dash of the vehicle and thereby brings the Cell Phone user/Driver's attention to the dashboard, the windshield and the road ahead.

Every time the device alarm activates, the Cell Phone user/Driver's attention is again brought back to the task of driving attentively.

### BACKGROUND

Cell phones are found to pose serious distractions for drivers. Among the many distractions faced by car drivers, cell phones and other wireless devices contributed to far and away the most crashes, near crashes and other incidents, according to a new government study.
(Wall Street Journal).

Using a Cellular Phone could raise crash risk, Advisory by the Insurance Institute For Highway Safety, # 21, April 1997

2002 Harvard study estimated that drivers using cell phones may cause 2,600 deaths a year nationwide and 330,000 injuries. New York Times Oct. 1, 2005 page A14
www.nysgtsc.state.ny.us/phon-ndx.htm
www.ncsl.org/programs/transportation/cellphoneupdate1203.htm
www.iii.org/media/hottopics/insurance/cellphones

What is claimed is:

1. A system for protecting motor vehicle drivers and passengers from the distraction of cell phone use while driving comprising:
a mobile telephone detection devise, which will automatically activate an alarm system contained therein.

2. A system as in claim 1, wherein said cell phone signal is detected.

3. A system as in claim 1, wherein said cell phone signal when detected activates an alarm.

4. A system as in claims 1, wherein said alarm is contained inside a device.

5. A system as in claim 1, wherein said device is mounted or embedded or displayed on the dashboard, or projected on the windshield.

6. A system as in claim 1, wherein the devise will, when activated, displayed a random flashing of lights for a random time sequence as well as random sounds for a random time sequence.

7. A system for protecting motor vehicle drivers and their passengers from the hazard of falling asleep while driving comprising:
a devise, which will automatically activate an alarm system contained therein.

8. A system as in claim 7, wherein an alarm device will be activated.

9. A system as in claim 7, wherein said device can be manually or automatically activated.

10. A system as in claim 7, wherein said device, when activated will cause an alarm sequence to begin.

11. A system as in claim 7, wherein said sequence will display a random flashing of lights for a random time sequence as well as random sounds for a random time sequence.
